(19) United States
(12) Patent Application Publication
(10) Pub. No.: US 2020/0160410 A1
(43) Pub. Date: May 21, 2020

(54) INFORMATION PROCESSING SYSTEM, PROGRAM, AND INFORMATION PROCESSING METHOD

(71) Applicant: TOYOTA JIDOSHA KABUSHIKI KAISHA, Toyota-shi (JP)

(72) Inventors: Eiichi KUSAMA, Anjo-shi (JP); Masatoshi Hayashi, Nisshin-shi (JP); Hisanori Mitsumoto, Hadano-shi (JP); Kuniaki Jinnai, Nagoya-shi (JP); Makoto Akahane, Shinjuku-ku (JP); Yuriko Yamaguchi, Shibuya-ku (JP); Daisuke Kato, Nisshin-shi (JP)

(73) Assignee: TOYOTA JIDOSHA KABUSHIKI KAISHA, Toyota-shi (JP)

(21) Appl. No.: 16/580,221

(22) Filed: Sep. 24, 2019

(30) Foreign Application Priority Data
Nov. 19, 2018 (JP) 2018-216671

(51) Int. Cl. G06Q 30/02; G06F 3/16; H04W 4/48; G01C 21/34; B60R 21/015; G08G 1/00; G06Q 10/02

(52) U.S. Cl. CPC G06Q 30/0282; G06F 3/167; H04W 4/48; G06Q 10/02; B60R 21/01538; G08G 1/22; G01C 21/3438

(57) ABSTRACT

An information processing system includes vehicles and a server. A vehicle generates an image by capturing a plurality of users who share a host vehicle. The vehicle or the server detects an interaction among the users based on the image and, based on a detection result, estimates each user's satisfaction level. The server accumulates data for each user wherein the data indicates an association between an attribute of another user and a user's satisfaction level, estimates a relationship between another user's attribute and a user's satisfaction level based on the accumulated data, preferentially selects, as a candidate, another user who has an attribute that increases the user's satisfaction level from among other users based on the estimated relationship when a service use request is received from a user's terminal device, and sends proposal information to the terminal device wherein the proposal information proposes a ride share with the candidate.

### INCORPORATION BY REFERENCE

The disclosure of Japanese Patent Application No. 2018-216671 filed on Nov. 19, 2018 including the specification, drawings and abstract is incorporated herein by reference in its entirety.

### BACKGROUND

### 1. Technical Field

The present disclosure relates to an information processing system, a program, and an information processing method.

### 2. Description of Related Art

Conventionally, techniques are known for detecting information about an object from an image captured by a camera. For example, Japanese Patent Application Publication No. 2013-000300 (JP 2013-000300 A) discloses a technique that calculates the index amount of each feature area of a user's face included in a plurality of captured images and, based on the level of correlation between the index amount and the base index amount of each feature area, determines the level of the user's mood.

### SUMMARY

In recent years, techniques are known that provide the so-called ride sharing service in which a plurality of unspecified users share and use one vehicle. For ride sharing service providers, collecting the information about user's satisfaction with the ride sharing service is useful for maintaining and expanding the business scale. In the ride sharing service, the level of satisfaction that the user feels for the ride sharing service can be influenced by compatibility with other users who share the vehicle. However, in the conventional technique for detecting the information about an object from an image captured by a camera, the compatibility with other users who share the vehicle is not considered. This means that the user's satisfaction with the ride sharing service cannot always be detected. Therefore, an improvement in the convenience of the technique for providing the ride sharing service is desired.

The present disclosure improves the convenience of the technique for providing the ride sharing service.

An information processing system according to one embodiment of the present disclosure is an information processing system including vehicles on each of which users of a ride sharing service ride; and a server that can communicate with the vehicles. The vehicle is configured to generate an image obtained by capturing a plurality of users who share a host vehicle. The vehicle or the server is configured to detect an interaction among the plurality of users based on the generated image and, based on a detection result of the interaction, to estimate a level of satisfaction of each of the plurality of users with respect to the ride sharing service. The server is configured to accumulate data for each user wherein the data indicates an association between an attribute of another user who rides with the user and a level of satisfaction of the user when the user rides with the another user, to estimate a relationship between an attribute of another user who rides with the user and a level of satisfaction of the user when the user rides with the another user based on the accumulated data, to preferentially select, as a candidate, another user who has an attribute that increases the level of satisfaction of the user from among a plurality of other users based on the estimated relationship when a service use request is received from a terminal device of the user, and to send proposal information to the terminal device wherein the proposal information proposes a ride share with the candidate.

A program according to one embodiment of the present disclosure causes a vehicle, on which users of a ride sharing service ride, to execute generating an image obtained by capturing a plurality of users who share a host vehicle; detecting an interaction among the plurality of users based on the generated image; and estimating a level of satisfaction of each of the plurality of users with respect to the ride sharing service based on a detection result of the interaction.

An information processing method according to one embodiment of the present disclosure is an information processing method performed by an information processing system including vehicles on each of which users of a ride sharing service ride; and a server that can communicate with the vehicles. The information processing method includes generating, by the vehicle, an image obtained by capturing a plurality of users who share a host vehicle; detecting, by the vehicle or the server, an interaction among the plurality of users based on the generated image; estimating, by the vehicle or the server, a level of satisfaction of each of the plurality of users with respect to the ride sharing service based on a detection result of the interaction; accumulating, by the server, data for each user, wherein the data indicates an association between an attribute of another user who rides with the user and a level of satisfaction of the user when the user rides with the another user; estimating, by the server, a relationship between an attribute of another user who rides with the user and a level of satisfaction of the user when the user rides with the another user based on the accumulated data; preferentially selecting, by the server, as a candidate, another user who has an attribute that increases the level of satisfaction of the user from among a plurality of other users based on the estimated relationship when a service use request is received from a terminal device of the user; and sending, by the server, proposal information to the terminal device wherein the proposal information proposes a ride share with the selected candidate.

According to one embodiment of the present disclosure, the convenience of the technique for providing ride sharing services is improved.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing a schematic configuration of an information processing system according to one embodiment of the present disclosure;

FIG. 2 is a block diagram showing a schematic configuration of a vehicle;

FIG. 3 is a block diagram showing a schematic configuration of a server;

FIG. 4 is a diagram showing an example of information stored in the server;

FIG. 5 is a diagram showing an example of information stored in the server;

FIG. 6 is a diagram showing a schematic configuration of a terminal device;

FIG. 7 is a flowchart showing the operation of the vehicle;

FIG. 8 is a flowchart showing a first operation of the server; and

FIG. 9 is a flowchart showing a second operation of the server.

### DETAILED DESCRIPTION OF EMBODIMENTS

An embodiment of the present disclosure will be described below in detail.

(Configuration of Information Processing System)

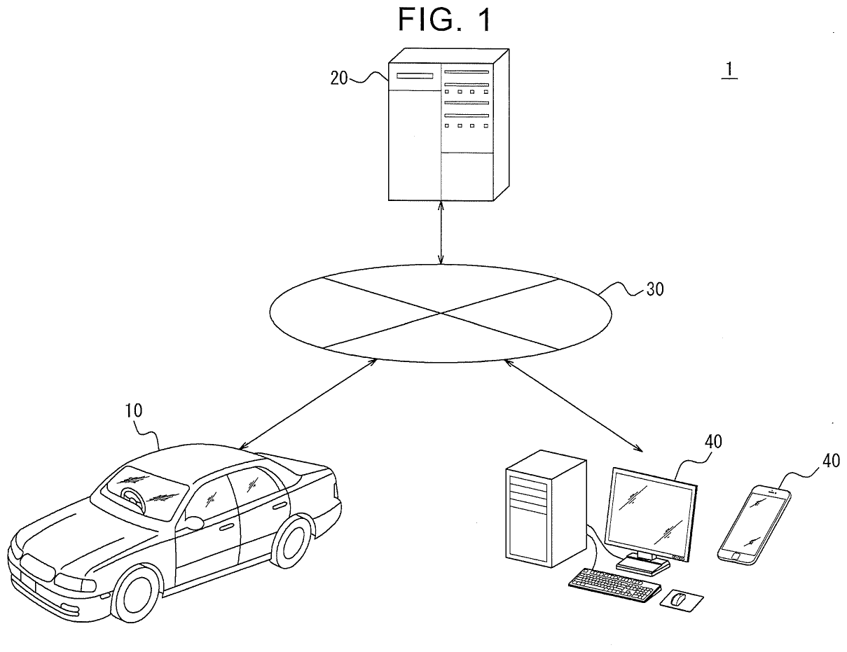

An overview of an information processing system 1 according to one embodiment will be described below with reference to FIG. 1. The information processing system 1 includes a vehicle 10 and a server 20. The vehicle 10 is, for example, an automobile; however, the vehicle 10 is not limited to an automobile but may be any vehicle. Although only one vehicle 10 is shown in FIG. 1 for ease of description, the information processing system 1 may include any number of vehicles 10. The server 20 includes one server device or a plurality of server devices capable of communicating with each other. The vehicle 10 and the server 20 can communicate via a network 30, for example, via a mobile communication network or the Internet. The server 20 can communicate with a terminal device 40 via the network 30. The terminal device 40 is, for example, a personal computer (PC) or a smartphone, but may be any information processing device.

In this embodiment, the information processing system 1 is used to provide the ride sharing service in which a plurality of unspecified users ride on one vehicle 10. Typically, the server 20 manages the information about each user of the ride sharing service. A user of the ride sharing service sends a service use request to the server 20 using the terminal device 40. In response to this request, the server 20 selects, as a candidate, another user who may share a ride with the user who has sent the service use request, for example, another user who is planning to use the vehicle 10 at the same date/time. After that, the server 20 proposes to the user a ride share with the candidate. When this proposal is accepted by the user, the server 20 accepts a reservation for a ride share of the vehicle 10 between the user and the candidate. In this way, the ride sharing service is provided.

The outline of this embodiment will be described first, and the details will be described later. As described above, the level of satisfaction that the user feels with the ride sharing service can be influenced by the compatibility with the other users who share the vehicle (hereinafter, also referred to as ride share partners). For example, when the compatibility among the users is good, the interaction among the users becomes active and the level of satisfaction may be high. Conversely, when the compatibility among the users is bad, the interaction among the users becomes inactive and the level of satisfaction may be low. That is, the level of user's satisfaction may be indicated by the interaction among the users sharing the vehicle 10. Therefore, the user's satisfaction with the ride sharing service can be estimated by detecting the interaction among the users who share the vehicle 10. The vehicle 10 according to this embodiment generates an image by capturing a plurality of users who share the host vehicle and, based on the generated image, detects the interaction among the plurality of users. Based on the detection result of the interaction, the vehicle 10 estimates the level of satisfaction of each of the plurality of users with respect to the ride sharing service.

Note that the compatibility between the user and a ride share partner may depend on the attribute (e.g., sex, etc.) of the ride share partner. For example, when a ride share partner has the same sex, some user may be more compatible with the ride share partner and, as a result, the level of satisfaction may tend to be higher. For example, when a ride share partner has the opposite sex, some user may be less compatible with the ride share partner and, as a result, the level of satisfaction may tend to be lower. Thus, for each user, there may be a certain relationship between the attribute of a ride share partner and the level of user's satisfaction. In other words, for each user, there may be a tendency of attribute that increases or decreases the level of user's satisfaction. Considering this tendency of attribute, the server 20 according to this embodiment accumulates, for each user, the data that indicates an association between the attribute of a ride share partner and the level of user's satisfaction that the user feels when the user rides with the ride share partner. Based on the data accumulated in this way, the server 20 estimates the relationship between the attribute of a ride share partner and the level of user's satisfaction. After the relationship is estimated, the server 20 can estimate the attribute of a ride share partner that will increase the level of user's satisfaction.

After that, when a service use request is received from the terminal device 40 of a user, the server 20 uses the relationship, estimated as described above, to preferentially select, as a candidate, another user who has the attribute that increases the level of user's satisfaction from among a plurality of other users. After selecting the candidate in this way, the server 20 sends proposal information, which proposes a ride share with the selected candidate, to the terminal device 40.

The level of user's satisfaction with the ride sharing service is estimated in this embodiment as described above. For ride sharing service providers, collecting the information about user's satisfaction with the ride sharing service is useful for maintaining and expanding the business scale. Therefore, the information about user's satisfaction, when collected as described above, improves the convenience of the technique for providing the ride sharing services. In addition, according to this embodiment, the next time the user uses the ride sharing service, a ride with another user who has an attribute that increases the level of user's satisfaction is proposed. Such a proposal increases the probability that the user's satisfaction will be maintained at a high level. Therefore, the convenience of the technique for providing the ride sharing services is further improved.

Next, the components of the information processing system 1 will be described below in detail.

(Configuration of Vehicle)

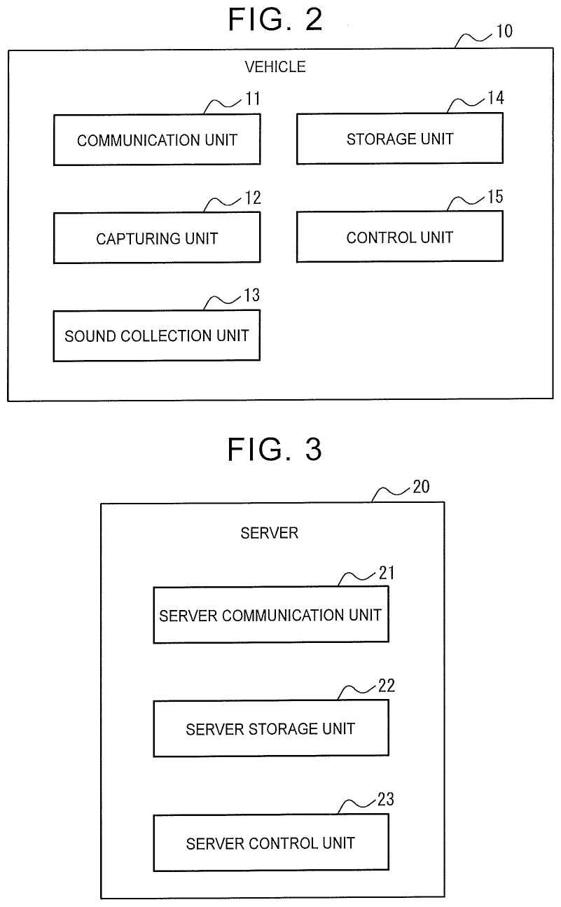

As shown in FIG. 2, the vehicle 10 includes a communication unit 11, a capturing unit 12, a sound collection unit 13, a storage unit 14, and a control unit 15. The communication unit 11, capturing unit 12, sound collection unit 13, storage unit 14, and control unit 15 may be built in the vehicle 10 or may be provided in the vehicle 10 in such a way that they are removed when unnecessary. The communication unit 11, capturing unit 12, sound collection unit 13, storage unit 14, and control unit 15 are communicably connected to one another via an on-vehicle network such as controller area network (CAN) or via a dedicated line.

The communication unit 11 includes a communication module for connection to the network 30. The communication module conforms to mobile communication standards such as the 4th generation (4G) and the 5th generation (5G). Note that the communication module is not limited to these standards but may conform to any communication standard. For example, an on-vehicle communication device, such as a data communication module (DCM), may function as the communication unit 11. In this embodiment, the vehicle 10 is connected to the network 30 through the communication unit 11.

The capturing unit 12 includes an on-vehicle camera that generates the image of an object in the field of view. In this embodiment, an “image” may include a still image and a moving image. The on-vehicle camera may be a monocular camera or a stereo camera. The capturing unit 12 is provided in the vehicle 10 so as to be able to capture the vehicle interior. In this embodiment, the vehicle 10 uses the capturing unit 12 to generate an image obtained by capturing a plurality of users who share the host vehicle.

The sound collection unit 13 includes a microphone. The sound collection unit 13 is provided in the vehicle 10 so as to be able to collect the sound in the vehicle interior. In this embodiment, the vehicle 10 uses the sound collection unit 13 to acquire the voices of a plurality of users who share the host vehicle.

The storage unit 14 includes one or more memories. In this embodiment, a “memory” is, but not limited to, a semiconductor memory, a magnetic memory, or an optical memory. Each memory included in the storage unit 14 may function as a main storage device, an auxiliary storage device, or a cache memory. The storage unit 14 stores any information to be used for the operation of the vehicle 10. For example, the storage unit 14 may store system programs, application programs, embedded software, and the like. The information stored in the storage unit 14 may be updatable, for example, with the information acquired from the network 30 via the communication unit 11.

The control unit 15 includes one or more processors. In this embodiment, a “processor” is, but not limited to, a general-purpose processor or a dedicated processor specialized for specific processing. For example, an electronic control unit (ECU) mounted on the vehicle 10 may function as the control unit 15. The control unit 15 controls the overall operation of the vehicle 10.

For example, the control unit 15 uses the capturing unit 12 to generate an image obtained by capturing a plurality of users who share the vehicle 10.

The control unit 15 detects an interaction among the plurality of users based on the generated image. More specifically, through image recognition, the control unit 15 recognizes each user's behavior, expression, and line-of-sight direction from the generated image and, based on the result of the image recognition, detects an interaction among the plurality of users. To detect an interaction, any method that uses the result of image recognition can be used. In one example, each time it is determined, based on the result of recognition (for example, the behavior of each user), that mutual communication such as a conversation was carried out among a plurality of users, the control unit 15 may determine that an interaction among the plurality of users was detected. In another example, each time it is determined, based on the result of recognition (for example, the behavior of each user), that mutual communication was carried out among a plurality of users and that a favorable user's reaction to the communication was detected (for example, the user's expression is a smile), the control unit 15 may determine that an interaction among the plurality of users was detected.

In this case, as the result of the detection of an interaction, the control unit 15 may determine at least one of the number of times of interaction detection among the plurality of users and the frequency of interaction detection among the plurality of users. The number of times of interaction detection means how many times an interaction was detected during the shared ride, while the frequency of interaction detection means how often an interaction was detected at intervals during the shared ride. In such a case, the result of the detection of an interaction among the plurality of users includes at least one of the number of times of interaction detection and the frequency of interaction detection. However, the result of the detection of an interaction among the plurality of users is not limited to the number of times of interaction detection and the frequency of interaction detection but may include any information about an interaction such as whether there was an interaction.

The control unit 15 estimates the level of satisfaction with the ride sharing service for each of a plurality of users based on the result of the detection of an interaction among a plurality of users. For example, the control unit 15 may determine that the level of user's satisfaction is higher as the number of times of interaction detection is higher and/or the frequency of interaction detection is higher. The level of user's satisfaction may be expressed, for example, as a numerical value or as a grade. After that, for each user, the control unit 15 sends the user ID, the ride share partner ID, and the level of satisfaction to the server 20. The user ID is the information uniquely identifying the user in the ride sharing service. The ride share partner ID is the user ID of another user (ride share partner) who rides with the user in the vehicle 10. Note that, for two or more ride share partners, the control unit 15 sends the ride share partner ID and the level of satisfaction to the server 20 for each ride share partner.

Together with or in place of an image obtained by capturing a plurality of users who share the vehicle 10, the control unit 15 may detect an interaction among a plurality of users based on the voices of the plurality of users acquired using the sound collection unit 13. More specifically, the control unit 15 recognizes a conversation among the plurality of users from the voices through voice recognition and, based on the result of the voice recognition, detects an interaction among the plurality of users. For detecting an interaction, any method using the result of voice recognition can be used. In one example, each time it is determined, based on the result of voice recognition, that a conversation was carried out among a plurality of users, the control unit 15 may determine that an interaction among a plurality of users was detected. In another example, each time it is determined, based on the result of voice recognition, that a conversation was carried out among a plurality of users and that a favorable user's reaction to the conversation was detected (for example, the conversation lasted for a long time), the control unit 15 may determine that an interaction among a plurality of users was detected.

(Configuration of Server)

As shown in FIG. 3, the server 20 includes a server communication unit 21, a server storage unit 22, and a server control unit 23.

The server communication unit 21 includes a communication module for connection to the network 30. The communication module conforms, for example, to the wired local area network (LAN) standard. Note that the communication module is not limited to this standard but may conform to any communication standard. In this embodiment, the server 20 is connected to the network 30 via the server communication unit 21.

The server storage unit 22 includes one or more memories. Each memory included in the server storage unit 22 may function as a main storage device, an auxiliary storage device, or a cache memory. The server storage unit 22 stores any information to be used for the operation of the server 20. For example, the server storage unit 22 may store system programs, application programs, and databases. The information stored in the server storage unit 22 may be updatable, for example, with the information acquired from the network 30 via the server communication unit 21.

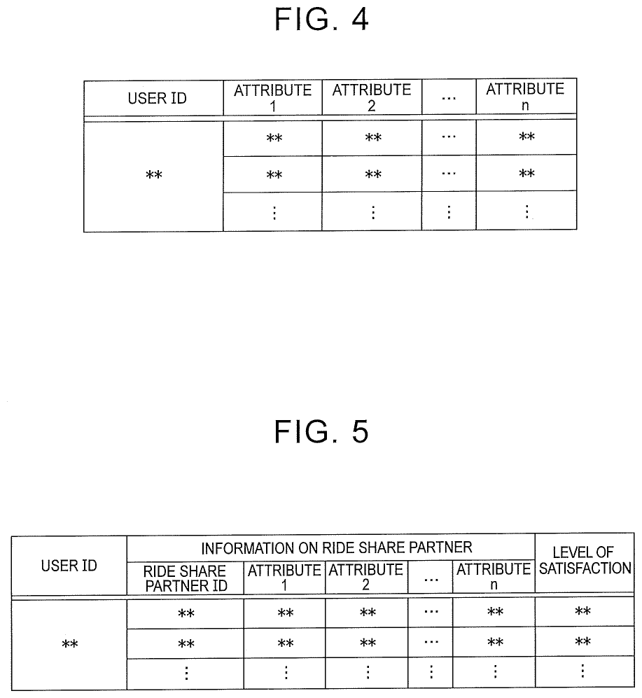

For example, the server storage unit 22 stores any information on each user of the ride sharing service. For example, the information on a user may include the user ID and one or more attributes. The attribute is any attribute of the user such as the user's sex, age, age group, occupation, hobby, or smoking habit. To protect the personal information on the user, the attribute may not include personal information that can uniquely identify the user. Although the number of attributes included in the information on the user is n in the example shown in FIG. 4, any number of attributes may be included in the information as long as one or more attributes are included. The user attribute may be acquired, for example, from the terminal device 40 of the user when the use of the ride sharing service is started or may be acquired from an external service such as a social networking service (SNS).

Also, the server storage unit 22 stores any information on a use reservation of the ride sharing service. For example, the information on a use reservation includes, but is not limited to, the vehicle ID of the vehicle 10, use date and time, departure place, destination, and user ID of each user who shares the vehicle 10. The vehicle ID is the information that can uniquely identify the vehicle 10 in the ride sharing service.

The server control unit 23 shown in FIG. 3 includes one or more processors. The server control unit 23 controls the overall operation of the server 20.

For example, when a user ID, a ride share partner ID, and a level of satisfaction are received from the vehicle 10, the server control unit 23 generates data that indicates an association among the ride share partner ID, the attribute of the ride share partner, and the level of user's satisfaction and accumulates the data in the database of the server storage unit 22. The attribute of the ride share partner is extracted from the server storage unit 22 with the ride share partner ID as the query key. For example, in the example shown in FIG. 5, the ride share partner information, which includes the ride share partner ID and one or more attributes, and the level of user's satisfaction are accumulated in association with the user ID of the user.

In addition, based on the data accumulated in the database, the server control unit 23 estimates the relationship between the attribute of each of the other users (ride share partners) who rides with the user and the level of user's satisfaction that the user will feel when the user rides with the ride share partner. In one example, the server control unit 23 may estimate the relationship by multivariate analysis in which the level of user's satisfaction is the target variable and each attribute of each of the ride share partners is the explanatory variable. In another example, the server control unit 23 may estimate the relationship by machine learning using the data accumulated in the database. More specifically, the server storage unit 22 stores a mathematical model (e.g., a neural network) in which each attribute of each of the ride share partners is the input data and the level of user's satisfaction is the output data. The server control unit 23 estimates the relationship by updating the mathematical model through supervised learning in which the data accumulated in the database is the learning data. In such a case, the learning data may include the attribute of each of the ride share partners as the input data and the level of user's satisfaction as the teacher data. However, the estimation of the relationship between the attributes of each of the ride share partners and the level of user's satisfaction is not limited to multivariate analysis and machine learning but any analysis method may be used.

After the relationship between the attribute of each of the ride share partners and the level of user's satisfaction is estimated, the server control unit 23 can estimate the level of user's satisfaction according to the attribute of each of the ride share partners based on the estimated relationship. For example, the server control unit 23 can predict the level of user's satisfaction that the user will feel when another user having a certain attribute and the user share on the vehicle 10. Also, the server control unit 23 can estimate the attribute of the ride share partner that will increase or decrease the level of user's satisfaction.

When a service use request, which will be described later, is received from the terminal device 40 of a user via the server communication unit 21, the server control unit 23 preferentially selects, as a candidate, another user from a plurality of other users based on the relationship estimated as described above. The selected user is a user who has an attribute that will increase the level of user's satisfaction. More specifically, by referring to a service use request received from the terminal device 40 of a user, the server control unit 23 identifies a plurality of other users who can ride with the user, for example, who are planning to use the vehicle 10 at the same date/time. The server control unit 23 predicts the level of user's satisfaction from the attribute of each of the plurality of other users and selects, as the candidate, another user who has the highest predicted level of satisfaction. However, the selection of a candidate is not limited to the example given above but any method may be used.

After selecting the candidate as described above, the server control unit 23 generates proposal information that proposes a ride with the selected candidate and, via the server communication unit 21, sends it to the terminal device 40 of the user. The proposal information includes, but is not limited to, the attribute of the candidate. For example, the proposal information may include any information about the use reservation of the ride sharing service such as vehicle information on the vehicle 10 (for example, vehicle type), use date and time, departure place, and destination. When a reservation request, which will be described later, is received from the terminal device 40 after sending the proposal information, the server control unit 23 determines the use reservation of a ride share of the vehicle 10 between the user and the candidate.

(Configuration of Terminal Device)

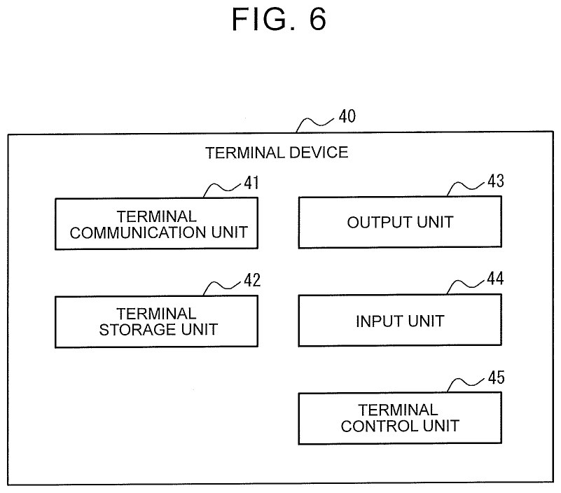

As shown in FIG. 6, the terminal device 40 includes a terminal communication unit 41, a terminal storage unit 42, an output unit 43, an input unit 44, and a terminal control unit 45.

The terminal communication unit 41 includes a communication module for connection to the network 30. For example, the terminal communication unit 41 may include a communication module that conforms to mobile communication standards such as 4G and 5G. In this embodiment, the terminal device 40 is connected to the network 30 via the terminal communication unit 41.

The terminal storage unit 42 includes one or more memories. Each memory included in the terminal storage unit 42 may function as a main storage device, an auxiliary storage device, or a cache memory. The terminal storage unit 42 stores any information to be used for the operation of the terminal device 40. For example, the terminal storage unit 42 may store system programs, application programs, and the like. The information stored in the terminal storage unit 42 may be updatable, for example, with the information acquired from the network 30 via the terminal communication unit 41.

The output unit 43 includes one or more output interfaces that output information to notify the user. For example, the output interface included in the output unit 43 includes, but is not limited to, a display that outputs information as an image or a speaker that outputs information as a voice.

The input unit 44 includes one or more input interfaces that detect an user input. For example, the input interface included in the input unit 44 includes, but is not limited to, a pointing device such as a mouse, a physical key, a capacitance key, a touch screen integrally provided with the display of the output unit 43, or a microphone for receiving a voice input.

The terminal control unit 45 includes one or more processors. The terminal control unit 45 controls the overall operation of the terminal device 40.

For example, in response to a user input from the user, the terminal control unit 45 sends a service use request to the server 20 via the terminal communication unit 41. A service use request includes, but is not limited to, the information on the use date and time on which the user desires to use the vehicle 10. For example, a service use request may also include any information on ride-sharing service use reservations, such as the vehicle information on the vehicle 10 the user desires (for example, vehicle type), the departure place, and the destination.

In addition, when proposal information is received from the server 20, the terminal control unit 45 outputs the proposal information via the output unit 43. The user of the terminal device 40 can determine whether to accept the proposal for sharing the vehicle with the candidate indicated in the proposal information, based on the proposal information that is output. Then, when a user input indicating the acceptance of the proposal is received from the user, the terminal control unit 45 sends a reservation request to the server 20. When the reservation request is sent, the use reservation of a ride share of the vehicle 10 between the user and the candidate is determined.

(Operation Flow of Vehicle)

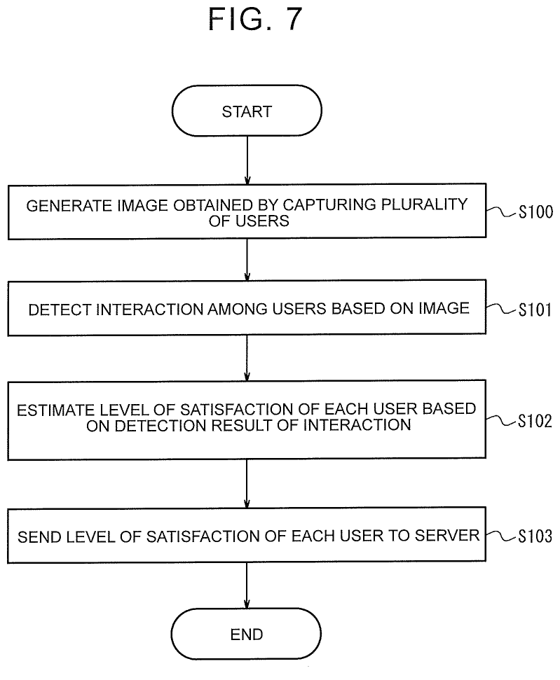

The flow of the operation of the vehicle 10 will be described below with reference to FIG. 7. In summary, the operation is performed to estimate the level of user's satisfaction of each of a plurality of users who share the vehicle 10.

Step S100: The control unit 15 uses the capturing unit 12 to generate an image obtained by capturing a plurality of users who share the vehicle 10.

Step S101: The control unit 15 detects an interaction among the plurality of users based on the generated image.

Step S102: The control unit 15 estimates the level of satisfaction of each of the plurality of users with respect to the ride sharing service based on the detection result of the interaction among the plurality of users.

Step S103: The control unit 15 sends the user ID, the ride share partner ID, and the level of satisfaction to the server 20 for each user.

(Operation Flow of Server)

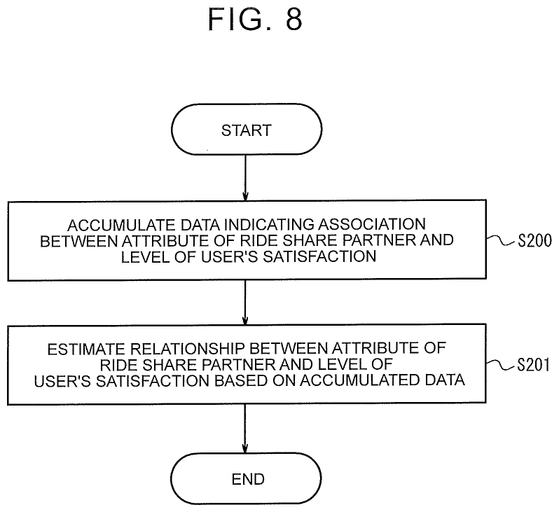

The flow of a first operation of the server 20 will be described below with reference to FIG. 8. In summary, the first operation is performed to estimate the relationship between the attribute of a ride share partner and the level of user's satisfaction.

Step S200: When a user ID, a ride share partner ID, and a level of satisfaction are received from the vehicle 10, the server control unit 23 generates data that indicates an association among the ride share partner ID of the ride share partner, the attribute of the ride share partner, and the level of user's satisfaction and accumulates the generated data in the database of the server storage unit 22.

Step S201: Based on the data accumulated in the database in this way, the server control unit 23 estimates the relationship between the attribute of another user (ride share partner), who rides with the user, and the level of user's satisfaction that the user will feel when the user rides with the ride share partner.

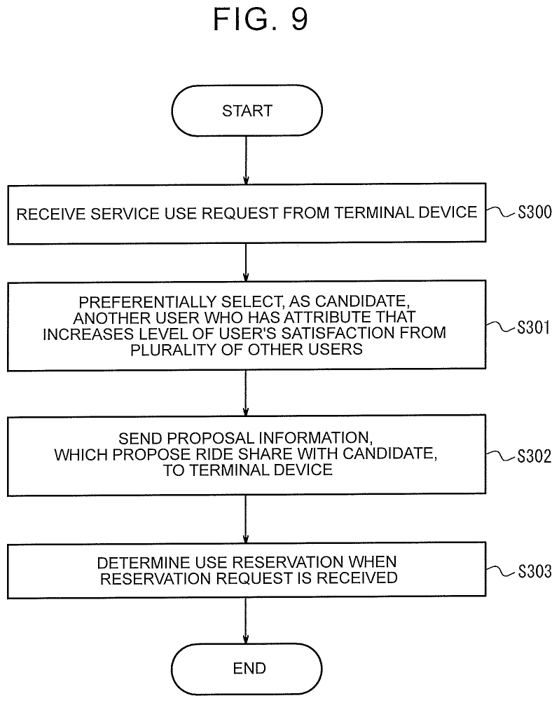

The flow of a second operation of the server 20 will be described below with reference to FIG. 9. In summary, the second operation is performed to send proposal information, which proposes a ride share with a candidate, to the terminal device 40 of the user. Note that the second operation is performed after the first operation described above.

Step S300: The server control unit 23 receives a service use request from the terminal device 40 of the user via the server communication unit 21.

Step S301: The server control unit 23 preferentially selects, as a candidate, another user who has the attribute that increases the level of user's satisfaction from a plurality of other users, based on the relationship estimated as described above.

Step S302: The server control unit 23 generates proposal information, which proposes a ride share with the selected candidate, and sends the proposal information to the terminal device 40 of the user via the server communication unit 21.

Step S303: When a reservation request is received from the terminal device 40 after sending the proposal information, the server control unit 23 determines the use reservation of a ride share of the vehicle 10 between the user and the candidate.

As described above, according to the information processing system 1 in this embodiment, the vehicle 10 detects an interaction among a plurality of users based on an image obtained by capturing the plurality of users who share the host vehicle. Based on the detection result of the interaction, the vehicle 10 estimates the level of satisfaction of each user. The server 20 accumulates data that indicates an association between the attribute of a ride share partner and the level of user's satisfaction and, based on this data, estimates the relationship between the attribute of the ride share partner and the level of user's satisfaction. When a service use request is received from the terminal device 40 of a user, the server 20 preferentially selects, as a candidate, another user who has an attribute that increases the level of user's satisfaction based on the estimated relationship. After that, the server 20 sends proposal information, which proposes a ride share with the candidate, to the terminal device 40.

The configuration described above allows for the estimation of user's satisfaction with respect to the ride sharing service. For ride sharing service providers, collecting the information about user's satisfaction with respect the ride sharing service is useful for maintaining and expanding the business scale. Therefore, the information about user's satisfaction, when collected as described above, improves the convenience of the technique for providing the ride sharing services. In addition, according to the configuration described above, the next time the user uses the ride sharing service, a ride with another user who has an attribute that increases the level of user's satisfaction is proposed. Such a proposal increases the probability that the user's satisfaction will be maintained at a high level. Therefore, the convenience of the technique for providing the ride sharing services is further improved.

Although the present disclosure has been described with reference to the drawings and embodiment, it should be noted that those skilled in the art can easily make various changes and modifications based on the present disclosure. Therefore, it is to be noted that these changes and modifications are within the scope of the present disclosure. For example, it is possible to relocate the functions included in each unit or each step in such a way that they are not logically contradictory, and it is possible to combine a plurality of units or steps into one or to divide a plurality of units or steps

For example, in the embodiment described above, a part of processing operations performed by the vehicle 10 may be performed by the server 20. For example, another configuration is also possible in which at least one of the two processing operations, (1) the processing for detecting an interaction among a plurality of users based on an image obtained by capturing the plurality of users who share the vehicle 10 and (2) the processing for estimating the level of satisfaction of each user based on the result of the detection of the interaction, is performed, not by the vehicle 10, but by the server 20. In such a case, the vehicle 10 does not perform the processing described above but directly sends the image to the server 20.

Furthermore, a still another configuration is also possible in which a general-purpose information processing device, such as a smartphone or a computer, is configured to function either as the components of the vehicle 10 or as the server 20 according to the embodiment described above. More specifically, a program describing the processing for implementing the functions of the vehicle 10 or the functions of the server 20 according to the embodiment is stored in the memory of the information processing device so that the processor of the information processing device can read for executing the program. Therefore, the disclosure according to this embodiment can also be implemented as a program that can be executed by the processor.

What is claimed is:

1. An information processing system comprising:
vehicles on each of which users of a ride sharing service ride; and
a server that can communicate with the vehicles, wherein
the vehicle is configured to generate an image obtained by capturing a plurality of users who share a host vehicle,
the vehicle or the server is configured to detect an interaction among the plurality of users based on the generated image and, based on a detection result of the interaction, to estimate a level of satisfaction of each of the plurality of users with respect to the ride sharing service, and
the server is configured to accumulate data for each user, the data indicating an association between an attribute of another user who rides with the user and a level of satisfaction of the user when the user rides with the another user, to estimate a relationship between an attribute of another user who rides with the user and a level of satisfaction of the user when the user rides with the another user based on the accumulated data, to preferentially select, as a candidate, another user who has an attribute that increases the level of satisfaction of the user from among a plurality of other users based on the estimated relationship when a service use request is received from a terminal device of the user, and to send proposal information to the terminal device, the proposal information proposing a ride share with the selected candidate.

2. The information processing system according to claim 1, wherein
the detection result of the interaction includes at least one of a number of times of the interactions and a frequency of the interactions, and
the vehicle or the server is configured to estimate that the level of satisfaction of each of the plurality of users is higher as the number of times of the interactions is larger and/or the frequency of the interactions is higher.

3. The information processing system according to claim 1, wherein
the vehicle is configured to acquire voices of the plurality of users who share the host vehicle and
the vehicle or the server is configured to detect the interaction among the plurality of users based on the generated image and the acquired voices.

4. The information processing system according to claim 1, wherein
the server is configured to estimate the relationship by supervised learning using the accumulated data as learning data.

5. A program that causes a vehicle on which users of a ride sharing service ride to execute:
generating an image obtained by capturing a plurality of users who share a host vehicle;
detecting an interaction among the plurality of users based on the generated image; and
estimating a level of satisfaction of each of the plurality of users with respect to the ride sharing service based on a detection result of the interaction.

6. An information processing method performed by an information processing system comprising vehicles on each of which users of a ride sharing service ride; and a server that can communicate with the vehicles, the information processing method comprising:
generating, by the vehicle, an image obtained by capturing a plurality of users who share a host vehicle;
detecting, by the vehicle or the server, an interaction among the plurality of users based on the generated image;
estimating, by the vehicle or the server, a level of satisfaction of each of the plurality of users with respect to the ride sharing service based on a detection result of the interaction;
accumulating, by the server, data for each user, the data indicating an association between an attribute of another user who rides with the user and a level of satisfaction of the user when the user rides with the another user;
estimating, by the server, a relationship between an attribute of another user who rides with the user and a level of satisfaction of the user when the user rides with the another user based on the accumulated data;
preferentially selecting, by the server, as a candidate another user who has an attribute that increases the level of satisfaction of the user from among a plurality of other users based on the estimated relationship when a service use request is received from a terminal device of the user; and
sending, by the server, proposal information to the terminal device, the proposal information proposing a ride share with the selected candidate.
